(19) United States
(12) Patent Application Publication
(10) Pub. No.: US 2007/0197164 A1
(43) Pub. Date: Aug. 23, 2007

(54) Method and device for automatic bluetooth pairing

(76) Inventors: Arnold Sheynman, Northbrook, IL (US); Brian A. Redding, Champaign, IL (US); Michael E. Russell, Lake Zurich, IL (US); Frederick J. Zimbric, Gurnee, IL (US)

Correspondence Address: MOTOROLA INC, 600 NORTH US HIGHWAY 45, ROOM AS437, LIBERTYVILLE, IL, 60048-5343, US

(21) Appl. No.: 11/362,295

(22) Filed: Feb. 23, 2006

(51) Int. Cl. H04B 7/00

(52) U.S. Cl. 455/41.2

(57) ABSTRACT

Described are a method and a Bluetooth device that upon powering up (202), the device automatically enters (306) discoverable mode without user intervention when its paired device list is empty (304). Also described is emptying (206) the paired device list. Further described is a method and Bluetooth device having one or more devices listed in its paired device list and wherein attempts are made at communication with the listed devices in one or more predetermined manners and if the attempts are not successful, automatically entering discoverable mode (306). Still further described is a method and device for attempting communication with the previously paired devices which may be interposed with entering into discoverable mode until either one is successful.

### FIELD

Described are a method and a Bluetooth device that upon powering up, the device automatically enters discoverable mode, and more particularly, disclosed is a method and device that establishes communication with another Bluetooth enabled device without user intervention.

### BACKGROUND

Bluetooth (BT) wireless technology provides a manner in which many wireless devices may communicate with one another, without connectors, wires or cables. Bluetooth technology uses the free and globally available unlicensed 2.4 GHz radio band, for low-power use, allowing two Bluetooth devices within a range of up to 10 to 100 meters to share data with throughput up to 2.1 Mbps. Each Bluetooth device can simultaneously communicate with many other devices.

Current common uses for Bluetooth technology include those for headsets, cellular car kits and adapters. Moreover, Bluetooth technology is currently used for connecting a printer, keyboard, or mouse to a personal computer without cables. Also, since Bluetooth technology can facilitate delivery of data, computers may use Bluetooth to provide a connection to the Internet. Mobile communication devices such as cellular telephones may transfer photos, video or ring tones between them. Additional functionality is expected to continue to expand.

Before two Bluetooth enabled devices may communicate, the devices must be paired. Bluetooth pairing occurs when the two Bluetooth enabled devices, unknown to each other, become a trusted pair. To become a trusted pair, the two Bluetooth devices must first complete a specific discovery and authentication process. When a first Bluetooth device recognizes a second Bluetooth device and they complete the specific discovery and authentication process, each device can automatically accept communication between them.

Device discovery is the procedure a Bluetooth wireless device uses to locate nearby Bluetooth wireless devices with which it wishes to communicate. Exchanging the Bluetooth addresses of the discoverable devices, their friendly names and other relevant information via establishing a short term connection with each device in the vicinity can be a time consuming procedure. The procedure can involve having one Bluetooth wireless device transmitting an inquiry request to other Bluetooth wireless devices scanning for inquiry requests. A device that transmits the inquiry request (a potential master) is said to be discovering other devices, or in discovering mode, while the device that is scanning for inquiry requests is said to be discoverable. The discoverable device (a potential slave) performs a process called inquiry scanning, during which it looks for an inquiry request. Once a discoverable device receives an inquiry request, it responds with Frequency Hopping Synchronization (FHS) packets. These packets include, among other fields, the discoverable device's 6-byte Bluetooth device address and 3-byte Class of Device (COD).

The master device is a device that initiates a connection. The device that accepts a connection becomes the slave device. For example, when the telephone initiates the discovery and pairing procedure it behaves as a master and the headset becomes a slave. Next time when the user powers the headset up the headset actively looks for the previously paired telephone, initiates connection to it and becomes a master. Upon accepting connection, the telephone becomes a slave. Furthermore, during the ongoing connection the master/slave roles can be switched if required.

When a connection has been established between the Bluetooth device such as a headset and another Bluetooth device, such as a telephone, a paired device list will list those devices with which a connection has been established and the Link Key has been exchanged. The list of discovered devices is presented to the user. The user may select the desired device to be paired with. In one example, the Bluetooth device is a headset, and another Bluetooth device is a mobile communication device such as a cellular telephone.

During the device discovery procedure it is possible to obtain further information from discoverable devices such as the Bluetooth devices friendly names. Accordingly, the discovering device sends a page request to Bluetooth device address(es) of the discovered device(s), at which point the discovering device initiates a short term connection with the discoverable device(s) and becomes a master. When a discoverable device responds to a page request, it becomes a slave. At this point, the devices are not paired, but the master can send a request for the slave's friendly name. For example, the friendly name may look like “Bluetooth Headset”.

Typically instead of the hexadecimal Bluetooth addresses the paired device list of devices' friendly names is presented to the user at the end of the discovery procedure. At this moment the user can select the Bluetooth wireless device he/she desires to start the communication with. After the user makes a selection, the discovering device can initiate a connection with the newly discovered device using the discovered device's Bluetooth device address. Without device discovery a Bluetooth wireless device would not know the Bluetooth device address of other Bluetooth devices which is required information for establishing a connection between the devices.

While in principal, the discovery process may be completed by following particular steps, oftentimes users are unsure of the procedure. In some situations, users may be unable to facilitate communication with previously paired device or are unable to complete the discovery process between two devices. In such a case, a Bluetooth accessory in particular may not be useful to them. Accordingly, it would be beneficial were there fewer steps that a user must accomplish to establish communication between two Bluetooth devices, such as a headset and a cellular telephone.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts two exemplary Bluetooth devices including a mobile communication device and a headset device;

FIG. 2 is a flow chart of an exemplary embodiment where in a testing process the paired device list may be populated by the testing device and subsequently emptied;

FIG. 3 is a flowchart of the exemplary Bluetooth device determining the state of its paired device list and either attempting communication with paired devices or entering into discoverable mode; and

FIG. 4 is an exemplary timing diagram showing timing for two Bluetooth enabled devices in the process of establishing communication.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Described are a method and a Bluetooth device that upon powering up, the device enters discoverable mode without user intervention when its paired device list is empty. Also described is emptying the paired device list. Further described is a method and Bluetooth device having one or more devices listed in its paired device list and wherein attempts may be made at communication with the listed devices in one or more predetermined manners, and if the attempts are not successful, automatically entering discoverable mode. Still further described is a method and device for attempting communication with the previously paired devices that may be interposed with entering into discoverable mode until either one is successful.

Accordingly, described is an embodiment in a Bluetooth device including a memory that can store a paired device list. The paired device list can list other Bluetooth enabled devices with which the Bluetooth device was previously paired. The method includes powering up the Bluetooth device, determining whether there is a device listed in a paired device list and automatically entering discoverable mode if there is no device listed in a paired device list.

Also described is an embodiment in a Bluetooth device including powering up the Bluetooth device and then determining whether there is a device listed in a paired device list. If the paired device list is not empty, the method includes attempting communication with at least one device listed in the paired device list. If attempting communication with one or more devices in the device list is not successful, the method can include automatically entering discoverable mode.

In another embodiment, attempting communication with devices in the pair device list may be interposed with entering discoverable mode, until either of the processes is successful. In this manner, user intervention is avoided since the processes of attempting communication and the entering into discoverable mode is automatic.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

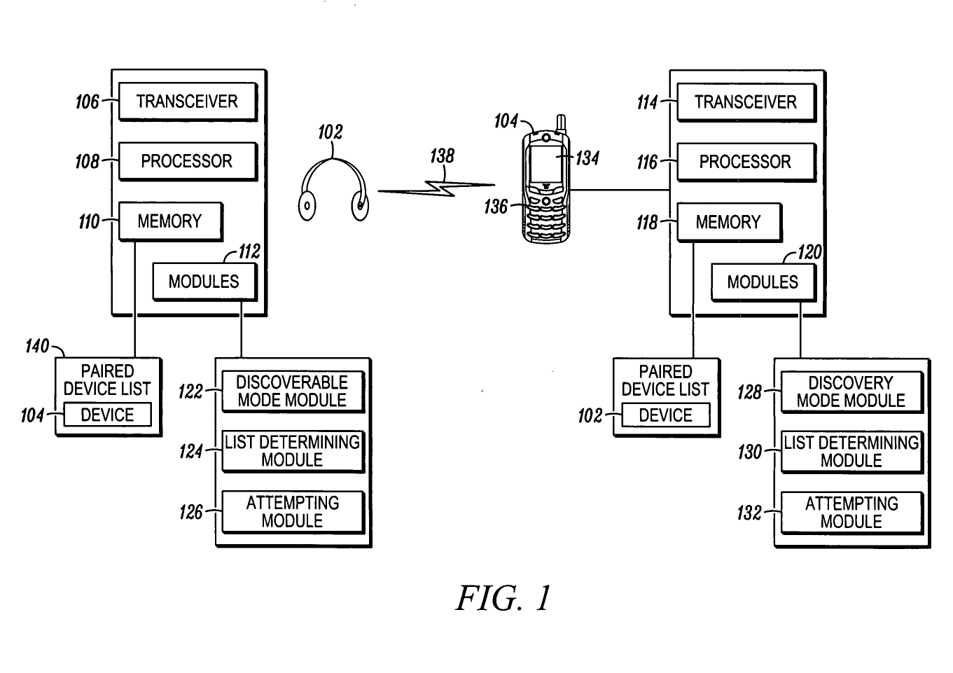

FIG. 1 depicts two Bluetooth devices including an exemplary mobile communication device and an exemplary headset device. Shown are a Bluetooth device 102 and a mobile communication device 104 having Bluetooth capabilities. The Bluetooth device as used in this discussion is any Bluetooth enable communication device. A cellular telephone may be a slave to another cellular telephone. More typically, a Bluetooth device may be a peripheral to another Bluetooth enabled device. For example, a Bluetooth enabled mouse may be a slave to a Bluetooth enabled personal computer or laptop computer. In any event both the Bluetooth device and the mobile communication device can be any type of device that is Bluetooth enabled.

A wide variety of Bluetooth enabled devices that have been developed and will be developed for use within various networks are included in this discussion. Handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, audio and music players and the like. Bluetooth enabled industrial devices may also be paired as described herein. Other devices such as personal computers, television sets and stereo equipment may also be paired with Bluetooth devices in the manner described herein.

The Bluetooth device 102 depicted in FIG. 1 can include a transceiver 106, a processor 108, memory 110, and modules 112. The mobile communication device 104 can similarly include a transceiver 114, a processor 116, memory 118, and modules 120.

The Bluetooth device 102 and the mobile communication device 104 are depicted with modules 112 and 120 respectively that can contain instruction modules that can be hardware and/or software to carry out various tasks. The modules can carry out certain processes of the methods as described herein. The modules can be implemented in software, such as in the form of one or more sets of prestored instructions, and/or hardware, which can facilitate the operation of the mobile communication device or Bluetooth device as discussed below. The modules may be installed at the factory or can be installed after distribution by, for example, a downloading operation. The operations in accordance with the modules will be discussed in more detail below.

The modules of the headset 102 and the mobile communication device 104 are illustrated as being similar. Of course, any other modules may be part of those devices. A discoverable mode module 122, list determining module 124 and attempting module 126 of the headset 102 are similarly shown with the mobile communication device 104 as discovery mode module 128, list determining module 130 and attempting module 132. If the roles of the devices were reversed, then headset 102 may have a discovery mode module and mobile communication device 104 may have a discoverable mode module. While mobile communication device 104 is shown with a display device 134 and an input device 136, similar devices may be included in the headset 102.

FIG. 1 may depict a circumstance where at the factory or along the distribution chain for the headset 102 where for quality testing purposes, it may be paired with a device 104 or another device such as a testing device. Communication 138 may be established between headset 102 and device 104 and thus the device 104 may be added to the paired device list. In memory 110 of the tested headset 102, there may be a paired device list which may list all the devices with which headset 102 has established communication. The paired device list 140 shows that headset 102 has established communication with mobile communication device 104. As mentioned, in a factory or distribution chain process, the device 104 may be a testing device specifically designed for quality assurance.

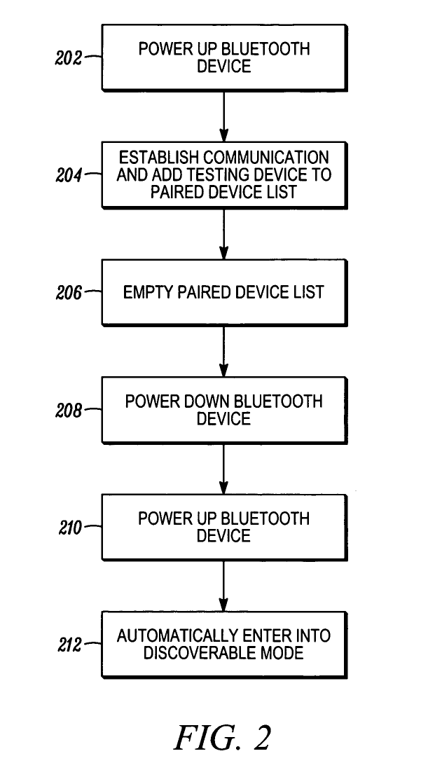

FIG. 2 is a flow chart of an embodiment where in a testing process the paired device list (see 140 of FIG. 1) may be populated by the testing device identification and may be subsequently emptied. The testing process may follow steps including powering up the Bluetooth device 202 and through the discovery process, establishing communication 204 such as that shown (see 138) between the devices of FIG. 1. Accordingly, the paired device list may be populated by the testing device identification name or code. Before the device is distributed, the paired device list can be emptied 206. The paired device list emptying procedure may include manual or speech input to the Bluetooth device, may be electronically effected or may be performed automatically. In the factory or distribution chain, a signal or electronic input may be sent to the Bluetooth device to clear or empty the paired device list. On the other hand, a manual input method or command to return the Bluetooth device into a “fresh” condition can be implemented by an input device such as a multifunction button in communication with its processor. The manual process to empty the paired device list can be for example, to press the multifunction button three consecutive times while the volume up button and the volume down button are continuously pressed. In any event, the device can be put into a “fresh” condition in any suitable manner. The device can be thereafter powered down 208.

After emptying the paired device list, the Bluetooth device may be powered up 210. For example, the device may be delivered to the end user with an empty paired device list. With the empty paired device list, the Bluetooth device can automatically be placed into discoverable mode 212. Accordingly, the Bluetooth device that is in discoverable mode can engage another Bluetooth enabled device in communication. Since the device may enter discoverable mode when its paired device list is empty, the user may not be required to follow procedures or instructions to place the device in discoverable mode when it is in its “fresh” condition, having an empty paired device list.

The other Bluetooth enabled device (see 104, FIG. 1) with which the Bluetooth device (see 102, FIG. 1) becomes engaged can then populate the paired device list (see 140, FIG. 1). Accordingly, the Bluetooth device may have one or more devices on its paired device list. After its initial power up, the Bluetooth device may be powered up a second time. In that event, if the list is populated, the device may attempt to communication with at least one device listed in the paired device list. If the attempt to establish communication with a device in the pair device list has failed, then the device can enter discoverable mode, automatically or by prompt. The reason for a failed attempt may be that the listed devices are not turned on or are not within range. Also, the user may wish to pair the Bluetooth device with another Bluetooth enabled device other than those listed in the paired device list. Accordingly, the user can position the new Bluetooth enabled device within range of the Bluetooth device so that after the failed attempts at communication with devices in the paired device list, the Bluetooth device may be placed in discoverable mode.

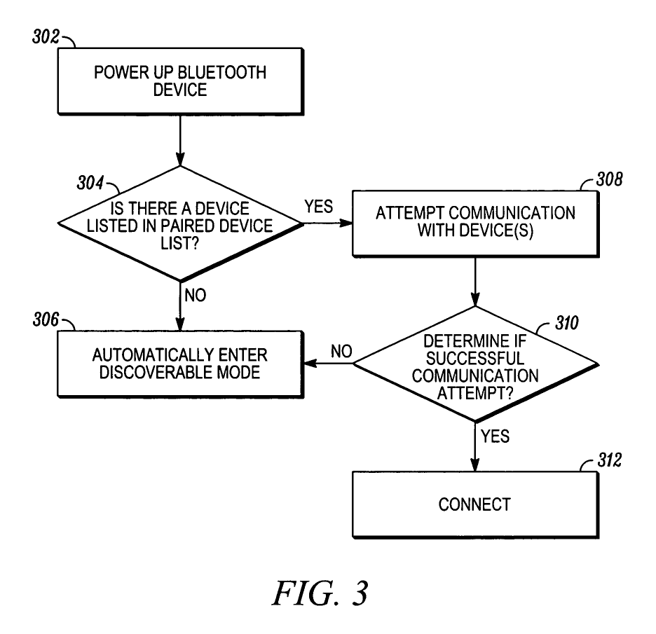

FIG. 3 is a flowchart of the Bluetooth device determining the state of its paired device list and either attempting communication with paired devices or entering into discoverable mode. The Bluetooth device is powered up 302 and there is a determination whether the paired device list is empty or populated 304. A list determining module may provide the instructions. If there is no device listed in the paired device list then the Bluetooth device automatically enters into discoverable mode 306. If the pair device list is nonempty 304, then a communication attempt is made with one or more Bluetooth enabled devices on the list 308. An attempting module may provide the instructions. If the attempt to communicate with device or devices on the paired device list is successful 310, then a connection may be established 312. If the attempt to communicate with a device or devices on the paired device list fails, then the Bluetooth device may automatically enter into discoverable mode 306. A discoverable mode module may provide the instructions.

It may be that the time required for scanning all known devices on the paired device list in an attempt to make communication 308 can be significant, such as for example between five to ten seconds for each one. If there are a number of devices on the paired device list, scanning through them all may be time consuming. Accordingly, the user may find the time to attempt to make connection 308 with all the devices in the paired device list too long. Therefore, a criterion may be placed upon the scanning process.

It may be likely that the last device in the paired device list is the one in close proximity so that communication can be established. Therefore, there may be an embodiment for attempting communication 308 including first attempting communication with the most recently paired device on the paired device list. Alternatively, another embodiment may be first attempting to communicate 308 with a plurality of the most recently paired devices on the paired device list.

Different connection attempting schemes or strategies 308 are possible. For example, after the Bluetooth device attempts communication with the last two recently paired devices in the paired device list, and there is failure to communicate 310, the device may automatically enter discoverable mode 314. Any variation in number or order of attempts to communicate and then automatically entering discoverable mode is within the scope of this discussion.

It may be that the time required for discoverable mode for either device, the Bluetooth device such as a headset and the Bluetooth enable device such as a mobile communication device, varies from manufacturer to manufacturer. Accordingly, time for establishing communication during discoverable mode may be variable from device to device. To avoid losing an opportunity to either establish communication with a device on the paired device list, or establish communication in discoverable mode, the two processes may be interposed. An embodiment can therefore include interposing periods during which the Bluetooth device is in discoverable mode between periods of attempting communication with the plurality of devices until a criterion is met. The criterion may be that an attempted communication with a device on the paired device list has been successful. Alternatively, a criterion may be that discovery has been successful. Other criteria are within the scope of this discussion.

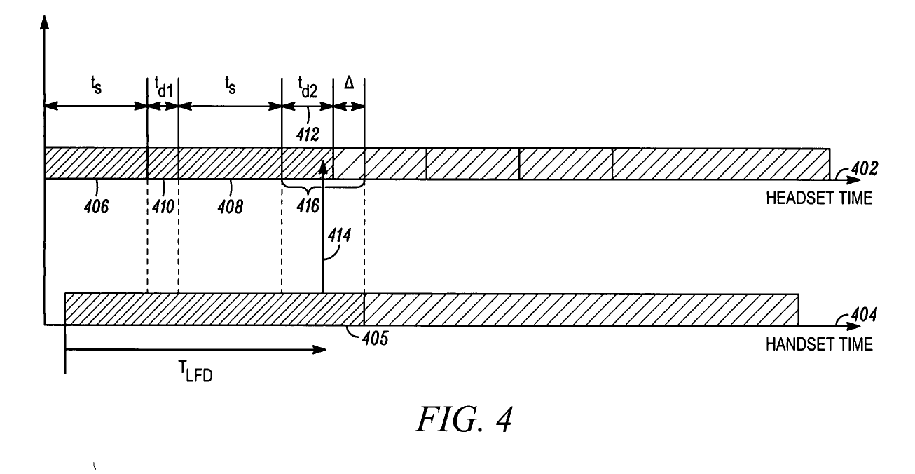

FIG. 4 is a timing diagram showing timing for two Bluetooth enabled devices in the process of establishing communication. For example, timing is shown for the headset time 402 and the handset time 404. Any type of Bluetooth enabled device may be represented in a similar manner. The tₛ may represent the scan time, that is, the time for attempting communication with devices on the paired device list, for example, in the manner in which was described above. Interposed between time tₛ, are time t_{d1} and time t_{d2}. The number of interposed time elements may be more or less than that shown in FIG. 4. T_{LFD} may represent the time the handset device is in discovering mode (see FIG. 1, discovery mode module 128). In the case of the handset 404, it is shown that the device is in discovering mode for the time T_{LFD}.

The two shown times tₛ 406 and 408 are similar in length and therefore extend for a predetermined period of time. They may be the same length or different lengths, or extending for random periods of time. However, time t_{d1} 410 and time t_{d2} 412 are shown as different lengths of time, but may be the same length. That is, the time t_{d1} 410 and time t_{d2} 412 may be the same for a predetermined period of time, may be for predetermined different periods of time, or may be for random periods of time.

As FIG. 4 shows, the headset 402 interposes two processes. It both attempts communication with devices on its paired devices list and it enters into discoverable mode. As show in FIG. 4, the handset 404 in discovering mode is nearby and therefore inquiry or inquiries may be received by the headset 402 when it is in discoverable mode. Arrow 414 shows that during one of the discoverable mode intervals, time t_{d2} 412, the headset 402 may respond to the discoverable mode inquiry by the handset 404. In another embodiment, the discoverable mode interval may be adaptive. Accordingly, even though the discovery process was set for a predetermined time t_{d2} 412, it is possible that the process may not be completed during that particular time interval of a certain length. Accordingly, the process may continue through time delta. The headset 404 therefore may be configured to adaptively increase the time t_{d2} 412 to time t_{d2}+delta to complete the discovery process between the handset and the headset.

In the event that the process of attempting to communicate with one or more devices in the paired device list fails, and establishing communication in discovery mode fails, the Bluetooth device may be configured to empty its paired device list to start as a “fresh” device. Different methods for emptying the paired device list were mentioned above. Once the paired device list is empty, the Bluetooth device, upon powering up can automatically enter discoverable mode, and therefore receive an inquiry from a device similarly in discoverable mode.

In summary, a Bluetooth device may upon powering up, automatically enter discoverable mode without user intervention. In the case where the paired device list is empty, the Bluetooth device maintains the discoverable mode until an inquiry from a different Bluetooth enabled device is received or timeout occurs. If the paired device list is non-empty, after attempting communication with a device in the paired device list, the Bluetooth device may be placed into discoverable mode. In another embodiment, in the case where one or more devices are listed in the paired device list, attempting communication with the devices and entering into discoverable mode may be interposed until either one is successful. Accordingly, the aforementioned or other criteria have therefore been met.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method in a Bluetooth device having a memory configured to store a paired device list, the method comprising:
powering up the Bluetooth device;
determining whether there is a device listed in a paired device list; and
entering automatically discoverable mode if there is no device listed in a paired device list.

2. The method of claim 1, further comprising:
adding a device to the paired device list; and
emptying the paired device list.

3. The method of claim 2, further comprising:
providing a user manual command to empty the paired device list.

4. The method of claim 2, further comprising:
providing a speech command to empty the paired device list.

5. The method of claim 2, further comprising:
providing an electronic input to the Bluetooth device to empty the paired device list.

6. A method in a Bluetooth device having a memory configured to store a paired device list, the method comprising:
powering up the Bluetooth device;
determining whether there is a device listed in a paired device list;
attempting communication with at least one device listed in the paired device list if the paired device list is nonempty; and
entering discoverable mode if attempting communication with the at least one device is unsuccessful.

7. The method of claim 6, further comprising:
retrieving the most recently paired device from the paired device list to attempt communication therewith.

8. The method of claim 6, further comprising:
retrieving a plurality of the most recently paired device from the paired device list to attempt communication therewith.

9. The method of claim 6, further comprising:
emptying the paired device list.

10. The method of claim 6, wherein the paired device list comprises a plurality of devices, the method further comprising:
interposing periods during which the Bluetooth device is in discoverable mode between periods of attempting communication with the plurality of devices until a criterion is met.

11. The method of claim 10, wherein attempting communication continues for a predetermined period of time.

12. The method of claim 10, wherein attempting communication continues for a random period of time.

13. The method of claim 10, wherein the Bluetooth device remains in discoverable mode for a predetermined period of time.

14. The method of claim 10, wherein the Bluetooth device remains in discoverable mode for a random length of time.

15. The method of claim 10, wherein the criterion comprises that attempting communication with at least one device is successful.

16. The method of claim 10, wherein the criterion comprises that attempting communication with the plurality of devices is unsuccessful.

17. A Bluetooth device, comprising:
a memory unit configured to store instructions;
a processor configured to execute instructions stored in the memory unit; and
a discoverable mode module with instructions configured to place the Bluetooth device in discoverable mode without user action when a criterion is met.

18. The Bluetooth device of claim 17, wherein the memory unit is further configured to store a paired device list, and wherein the criterion comprises that no devices are listed in a paired device list.

19. The Bluetooth device of claim 17, wherein the memory unit is further configured to store a paired device list, and wherein the criterion comprises that attempting communication with at least one device on the paired device list has failed.

20. The Bluetooth device of claim 17, wherein the Bluetooth device is a headset.
